(19) United States
(12) Patent Application Publication
(10) Pub. No.: US 2011/0278329 A1
(43) Pub. Date: Nov. 17, 2011

(54) Measuring Storage Container

(76) Inventor: Linda Enns, Ontario (CA)

(21) Appl. No.: 13/105,761

(22) Filed: May 11, 2011

Related U.S. Application Data
(60) Provisional application No. 61/334,609, filed on May 14, 2010.

(51) Int. Cl. G01F 11/28

(52) U.S. Cl. 222/434; 222/454; 222/440; 222/438

(57) ABSTRACT

A storage and measurement container for retaining a quantity of particulate food product and dispensing a measured serving thereof. The container comprises a rectangular storage volume with a removable lid, wherein food stuffs such as flour, spices and other products may be preserved for extended periods of time and likewise dispensed therefrom. The lid is attachable to the container, and comprises an interior volume and a closure blade. Within the lid is a means to adjust its interior volume by method of inserting or retracting a graduated piston, which changes a desired serving. The blade is first used to retract the piston prior to the assembly being rotated and food contents transferred from the container to the lid interior volume. The blade is then used to separate the container volume from the lid volume after the container has been rotated and prior to dispensing the lid contents. A lid door provides a means to dispense the product after the blade has been inserted. The device provides a convenient and simple food product container that allows dispensing of a measured quantity of product from a larger container without the use of a third party measuring device.

### CROSS REFERENCE TO RELATED APPLICATION

This application claims the benefit of U.S. Provisional Application No. 61/334,609 filed on May 14, 2010, entitled “Store and Measure Container.”

### BACKGROUND OF THE INVENTION

1. Field of the Invention

The present invention relates to containers for particulate food stuffs. More particularly, the present invention relates to a combined storing, measuring and dispensing device.

The present invention pertains primarily with flowing particulate food stuffs, which may be assumed to encompass any granular, crystalline, particulate flake, powder or similarly structured product that can flow from one vessel to another in solid form. This differs from fluid communicating devices or containers.

2. Description of the Prior Art

Graduated measuring cups are well known in the art, and provide a means to measure quantities of a product while preparing or serving food. These are generally singular or a set of graduated measuring devices with a visible measurement scale for reference along their interior or exterior surfaces, allowing a user to accurately measure a serving size or follow recipe instructions. These devices comprise stackable cups, spoons, cylinders and other structures whose sole purpose is to measure a quantity of food product and provide a dispensing means thereof.

Storage containers for granular food products such as spices, sugar and similar ingredients are likewise well described in the art. These devices are typically resealable containers that provide an air tight or vacuum seal lid for preserving interior contents for periods of time. The ability to adequately seal the contents slows any aerobic process that may result in spoilage or loss of freshness. These devices are generally formed of acrylic or similar plastic material with no means to accurately dispense a given quantity of product without use of a measuring device.

The present invention discloses a combination storage container, measurement and dispensing device that provides all of the benefits of its individual components combined into a convenient and efficient structure. The device is comprised of four main parts: a base storage container, a lid with an interior volume, measuring device and a separation blade. These components work together to provide a long-term storage container, a measurement lid attachable to the container, and a blade device that separates the measured volume from the rest of the container contents prior to dispensing. The means provided for shifting contents from one volume to another is a rotation of the assembly, followed by the blade separating the two volumes.

Several devices have been disclosed in the art that describe container measuring devices, including those that are one-piece or assemblies that facilitate controlled communication of solid or fluid products from a container. These devices are generally less efficient or less modular than the present invention, or provide a one-piece device that does not function particularly well as a storage container.

U.S. Pat. No. 4,646,948 to Jennings describes an improvement in container measuring systems wherein discrete quantities of liquid may be measured and dispensed using a pour-spout and measuring head, attachable to the spout of a fluid container. While this device is useful for dispensing fluid products, it lacks the ability to provide a useful measuring means for granular food stuffs. It also differs in structure and function from the present invention.

U.S. Pat. No. 5,556,011 to Jennings describes another measuring container device wherein a secondary measurement vessel is provided along the top of a container filled with flowable solid material. Upon flipping the container over, solid particles are communicated into the secondary vessel through a small opening. This device provides an inefficient means of transferring material from a main chamber and into the secondary measuring vessel. The food particles must actively flow around a bend and through a small channel in order to enter the measuring vessel, which may prove difficult with larger particulate material. The flow rate and inherent viscosity of such products may prohibit ease of movement through a small channel or around a curve. The present invention alternatively provides a direct means of communication that can be closed off after the product has entered the measuring volume of the lid and is ready for dispensing. No small pathways or undulating geometry is necessary to communicate particles from one vessel to the other.

U.S. Pat. No. 5,601,213 to Daniello describes a container lid with quantity measures for selectively dispensing different predetermined quantities of material. The lid includes a rotatable head and a body structure with plurality of measuring volumes therein. The head is rotated to the desired serving and the assembly is flipped over to fill the measured volume. A closure plate between the measured volume and the container volume is used to separate the two prior to dispensing. While this device employs a tilt mechanism to transfer between volumes and a closure plate to separate the two, its primary usefulness lies in smaller containers, such as spices and similar small quantity vessels. The rotary motion of the head is also different in structure from the present invention, which utilizes a slideable piston-type device to change the measured volume within the lid, as opposed to choosing a preselected volume by rotation.

In these respects, the aforementioned patents fail to describe the present invention. The devices in the prior art have drawbacks that prevent their use as a particulate container of food stuffs while providing an efficient means to dispense a measured quantity thereof. The instant invention substantially diverges in design elements from the prior art and consequently it is clear that there is a need in the art for an improvement to existing container measurement systems and combined dispensers. In this regard the instant invention substantially fulfills these needs.

### SUMMARY OF THE INVENTION

In view of the foregoing disadvantages inherent in the known types of measured container dispensers now present in the prior art, the present invention provides a new dispensing container wherein the same can be utilized for providing convenience for the user when efficiently measuring and dispensing a quantity of solid food product from a larger storage container.

It is therefore a primary objective of the present invention to provide a means of measuring and dispensing a known quantity of flowable solid material from a container utilizing no external measurement means.

Another object of the present invention is to provide an efficient and modular container dispensing system that allows a user to store food product in a larger container for periods of time, and provide a container lid that is capable of measuring a desired quantity therefrom and dispense that quantity using no external measuring means.

Another object of the present invention is to provide direct communication of material between a storage container to the measured volume within the lid structure, along with a blade device to separate the two prior to dispensing.

Yet another object of the present invention is to provide a measuring lid and container device that is easily cleaned, and one that provides an adequate seal to prevent spoilage or loss of freshness.

A final object of the present invention to provide a new and improved measured container dispenser device that has all of the advantages of the prior art and none of the disadvantages.

Other objects, features and advantages of the present invention will become apparent from the following detailed description taken in conjunction with the accompanying drawings.

### BRIEF DESCRIPTIONS OF THE DRAWINGS

FIG. 1 shows the present invention wherein the measuring piston is being positioned to a create a desired volume within the measurement lid.

FIG. 2 shows the method of material communication between the container and the lid interior volume.

FIG. 3 shows the present invention in its dispensing position.

### DETAILED DESCRIPTION OF THE INVENTION

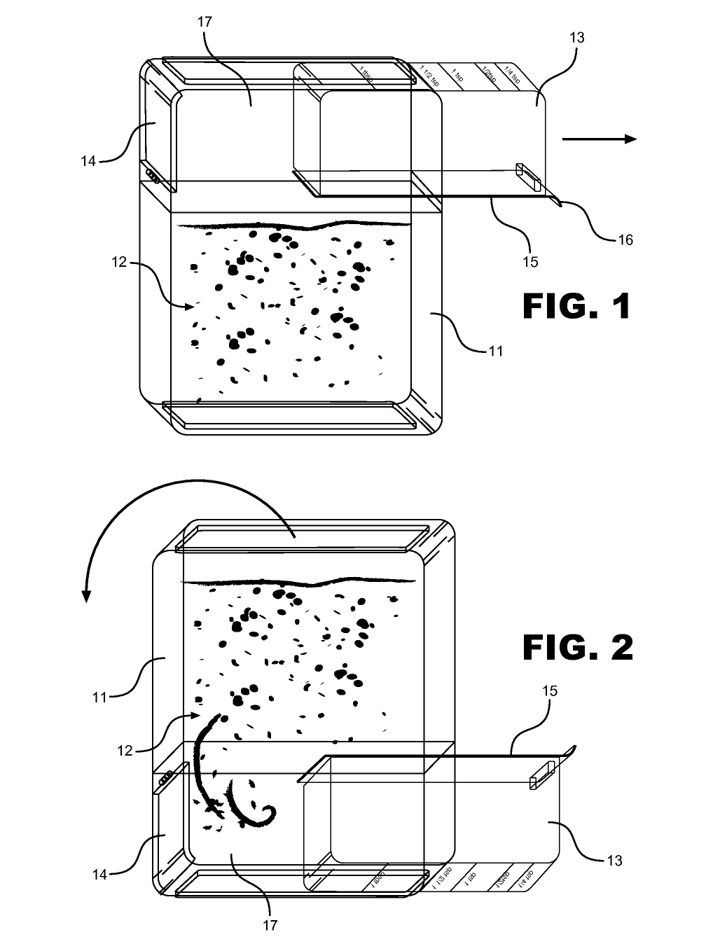

Referring now to FIG. 1, there is shown a perspective view of the present invention, wherein a storage container 11 with an interior volume is filled with granular food contents 12. Above the storage container 11 is a measuring lid, comprising a slideable measuring piston 13 with a graduated scale of measurements along its upper surface, a containment blade device 15 with a handle lip 16, an interior volume 17 and a dispensing door 14. The measuring piston 13 is pulled from the measuring lid interior until a desired volume measurement is uncovered, corresponding to an interior volume 17 within the lid structure. When pulled outward from the lid, the measuring piston 13 and the blade 15 travel in unison, as a one-way latch device pulls the piston 13 out of the lid as the blade 16 is pulled. When pushed into the lid, the blade 15 moves independently of the piston 13, allowing separation of the lid interior volume 17 and the container volume 11. The latch provides a bearing surface for the blade to pull the piston in unison, while freeing the blade from the piston when the blade is pushed back into the lid. The piston 13 and blade 15 slide along corresponding slots within the cavity 17 of the lid, and provide a seal to prevent contents 12 from exiting the lid except through the dispensing door 14 when in use.

Referring now to FIG. 2, there is shown a perspective view of the present invention in its transfer position, wherein the assembly is flipped over from its original position (FIG. 1), allowing contents 12 to flow from the container 11 into the lid interior volume 17. The displacement of the measuring piston 13 determines the internal volume 17 within the lid, and therefore the intended serving size. The serving size is indicated along the top surface of the piston 13. In this figure, the separation blade is in an open position, allowing a clear pathway between the lid 17 and the container 11. The dispensing door is 14 held shut via a hinge and attachment means along its opposite edge.

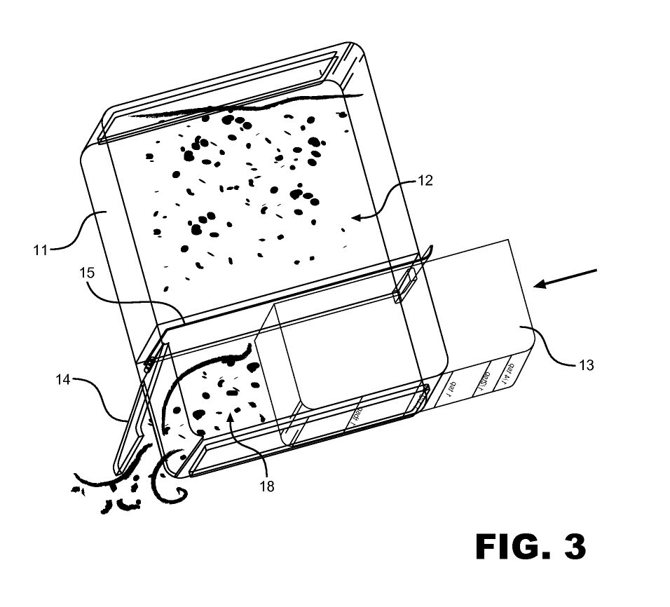

Referring now to FIG. 3, there is shown a perspective view of the present invention in its dispensing position. Contents from the container 12 have been transferred to the lid interior volume, creating a measured quantity of contents 18 for the user. The separation blade 15 has been moved into its working position, wherein it separates the container and lid volumes and prevents leakage from the former. At this time, the door 14 is opened by the user to allow the measured contents 18 to escape the assembly and to be dispensed accordingly.

In use, the present invention provides an easy to use and efficient method of measuring a quantity of food stuffs from a container and dispensing it therefrom. The graduated piston allows contents to be measured prior to delivery, while the remainder of the contents is securely housed within the container and prevented from spilling out. The rotating action and clear pathway between the container and the lid ensures efficient communication of material, eliminating any transfer problems associated with denser or highly viscous materials. Food products contemplated for use with this product include any household food product that requires measurement or one that is stored in a sealable container prior to use, including flour, spices, sugar, cereal, oats or any other similar flowable solid material composition.

The container may come in any size or in a plurality of sizes that allows for a set of containers. The measured volumes may likewise comprise any graduated scale preferred by the user, including teaspoons or cups and with 1/4 graduation marks. The top surface of the container lid is mateable to the bottom surface of the container, allowing the user to securely stack multiple measuring container devices.

Materials for the device may be chosen from any known materials used for food storage, including acrylic and other plastics, stainless steel and aluminum. In a preferred embodiment of the present invention, the container is made of clear acrylic, while the lid comprises of stainless steel construction. It is not intended to limit the present invention to a specific material type, but rather it has been shown that this combination yields a device that allows for ease of use, ease of cleaning and improved manufacturability.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A measurement storage container for dispensing measured servings of flowable contents, comprising:
a storage container in connection with a lid with an interior volume, wherein said flowable contents are communicated from said container to said lid interior volume upon a tilting action from an initial position to a tilted position, whereby contents are gravity fed from said container to said lid;
said lid comprising a slideable piston, a blade separation device and a dispensing door;
said slideable piston creating a measured volume within said lid determined by its slideable position;
said blade separation device slideable between said container and said lid measured volume to eliminate communication of contents;
said dispensing door hingedly attached to said lid that allows dispensing of contents from said lid.

2) A device as in claim 1, wherein said piston and said blade separation device are slideable along a rail device, allowing fore-aft motion and secure containment of contents within said lid.

3) A device as in claim 1, wherein said piston and said blade separation device are connected via a one-way latch that provides unitary motion as said lid interior volume is expanded.

4) A device as in claim 1, wherein said blade separation device extends beyond said piston and forms a lip for improved ergonomics.

5) A device as in claim 1, wherein said container and said lid comprise a rectangular cross section.

6) A device as in claim 1, wherein said container is clear acrylic and said lid is stainless steel.

7) A device as in claim 1, wherein said door is latched opposite said hinged attachment.

8) A device as in claim 1, wherein said piston upper surface displays a graduated measurement scale that corresponds to said lid interior volume.

9) A device as in claim 1, wherein a plurality of said measurement storage containers are stackable, secured by corresponding grooves along said lid upper surface and said container lower surface.

10) A method of measuring a desired serving of flowable contents from a container, comprising the steps of:
attaching a measuring lid to a container filled with flowable contents;
tilting said container and measuring lid to communicate said contents of said container to said measuring lid interior volume, defined by a piston device;
positioning a blade separation device between said container volume and said measuring lid to prevent further communication of contents;
opening a door on said measuring lid to dispense said lid interior contents.
